(19) United States
(12) Patent Application Publication
(10) Pub. No.: US 2010/0282412 A1
(43) Pub. Date: Nov. 11, 2010

(54) METHOD OF MAKING A PROTECTIVE FILM

(76) Inventors: Dieter DOHE, Lengerich (DE); Klaus-Peter Lebkuecher, Lengerich (DE)

Correspondence Address: KF ROSS PC, 5683 RIVERDALE AVENUE, SUITE 203 BOX 900, BRONX, NY, 10471-0900, US

(21) Appl. No.: 12/775,602

(22) Filed: May 7, 2010

(30) Foreign Application Priority Data
May 9, 2009 (DE) 102009020624.8

(51) Int. Cl. B32B 43/00; B29C 47/06; B29C 59/04

(52) U.S. Cl. 156/344; 264/175; 264/173.16

(57) ABSTRACT

A protective film is made by extruding a molten-plastic film from a slit nozzle into a nip formed between an outer face of a rotatable roll and a face of a metal belt. One of these faces is smooth. The belt is tensioned to press the film in the nip between the belt and the roll outer face. The belt or the roll is cooled to harden the film such that one face of the film engaging the smooth face of the roll or belt is rendered smooth and free of defects.

### FIELD OF THE INVENTION

The present invention relates to protective film. More particularly this invention concerns a method of making such a film.

### BACKGROUND OF THE INVENTION

A typical surface-protection film has a high-gloss surface on one side and an opposite matte side. Such a film is used, for instance, to protect products made from plastic by deep drawing for example, so they have a good surface quality and a high gloss. Typical such products are plastic bathroom tubs, helmet visors, and plastic housings for high-quality electronic parts such as displays. To protect the plastic surface during is manufacture and transport, the protective film is applied as soon as possible in the manufacturing or assembly process, for removal by the end user. To ensure that the film can be pulled off easily and without any residue, protective films do not have an adhesive layer, but instead adhere to the surface that is to be protected because of the high-gloss surface, i.e. as a result of the so-called glass-pane effect. The adhering side of the adhesiveless protective film is very smooth and attaches itself to the also smooth surface that is to be protected. The thickness of the protective film is less than 150 μm, thinner films with a thickness of a maximum of 120 μm being preferred from an application perspective.

To prevent the film from sticking on the roll when the it is unrolled, the other side of the film is given a rough surface or embossed surface, it is provided with antistick additive.

On its smooth side, the protective film always has a certain number of surface defects in the form of fish eyes, for example, as the result of local contamination, unmelted material, overheated material, or in the form of nozzle strips that are caused by unevenness or contamination of the extrusion nozzle. The defects are localized thickenings that project from the glossy surface and can lead to impairment of the adhesive properties and to marking of or damage to the glossy surface of the object that is to be protected.

U.S. Pat. No. 5,100,704 describes a multilayer protective film with a smooth side and a matte embossed side. The film is coextruded and then run through an embossing step during which the matte side of the film is produced. On the smooth side, a surface roughness of approximately 0.25 and 10 Rₐ can be achieved, but up to ten surface defects in the form of fish eyes per square meter have to be tolerated.

In U.S. Pat. No. 5,693,405, a multilayer, adhesive-free protective film is described, which is produced as coextrusion film. The coextrusion film passes through a pair of rollers after the extrusion, namely a first roller with a smooth surface and a second roller with an embossed surface. The protective film produced according to this method has a smooth side and a matte or embossed side. The presence of surface defects in the form of fish eyes, and also nozzle strips that are caused by unevenness or contaminations of the extrusion nozzle cannot be avoided.

GB 2,323,057 describes glazing rollers for the production of plates and films made of thermoplastic plastic that are smoothed on both sides, the smoothed materials having a thickness between 0.5 and 50 mm. The glazing rollers are formed by a smoothing roll and a metal belt guided around two deflecting rolls adjacent the smoothing roll to partially loop around it.

### OBJECTS OF THE INVENTION

It is therefore an object of the present invention to provide an improved method of making a protective film.

Another object is the provision of such an improved method of making a protective film that overcomes the above-given disadvantages, in particular that produces a film having at least a high-gloss and zero-defect surface on one side.

### SUMMARY OF THE INVENTION

A protective film is made by extruding a molten-plastic film from a slit nozzle into a nip formed between an outer face of a rotatable roll and a face of a metal belt. One of these faces is smooth. The belt is tensioned to press the film in the nip between the belt and the roll outer face. The belt or the roll is cooled to harden the film such that one face of the film engaging the smooth face of the roll or belt is rendered smooth and free of defects.

The smoothing belt is, for example, a revolving continuous steel belt. By using the smoothing belt, the so-called sleeve belt, optimal optical and mechanical properties are achieved in the films that are produced. As a result of the surface-contact on the molten plastic film entering the gap while cooling starts simultaneously, surface defects, for example, as a result of partial contaminations, unmelted material, overheated material, unevenness or contaminations of the extrusion nozzle or the like are effectively eliminated. Further, it is advantageous that as a result of the high cooling speed that occurs in the method according to the invention, the formation of crystallites can be suppressed and films are created in amorphous structures, which are shrivel-free and shrink-free.

The surface quality of the glossy surface can be influenced by the surface consistency of the cooling roll and/or the smoothing belt. According to a preferred embodiment of the invention, the contact surface of the cooling roll that acts upon the molten-plastic film and/or the smoothing belt has a surface roughness Rₜ of less than 10 μm, preferably a surface roughness of less than 1 μm, surface roughness Rₜ being the distance between the surface peaks and the surface troughs. The contact surface of the cooling roll or the smoothing belt have a surface that is improved by a finishing, for example, by honing, ultrafine grinding, fine or ultrafine lapping, or can be provided with a coating that provides the surface quality. As coating, chrome or galvanic coatings come into consideration.

Protective films can be produced with the method in accordance with the invention that have a high-gloss surface without any surface defects on both sides. Glossy surfaces on both sides are often desired when the protective film is intended to be very transparent. To avoid such a film sticking to itself when rolled up, a separating layer can be rolled up with it.

But with the method in accordance with the invention, especially protective films can also be produced that have one high-gloss side and an opposite matte side, by correspondingly selecting the surfaces of the cooling roll and the smoothing belt. An embodiment of the method in accordance with the invention therefore provides that only the cooling roll or only the smoothing belt has a smooth contact surface acting upon the molten-plastic film for the production of a high-gloss film surface and that the counter surface acting upon the molten-plastic film is designed as a rough surface in order to produce a matte film surface that does not adhere to smooth surfaces. The term rough surface also includes embossed surfaces.

By a few targeted experiments, the loop region in which the smoothing belt engages upon the cooling roll can be specified, and also the suitable belt tension for generating the contact pressure. The loop region in which the smoothing belt acts upon the cooling roll is, as a rule, smaller than the cooling section in which the molten-plastic film abuts at the cooling roll and corresponds, for example, to a looping angle between 15° and 90°.

The protective film is preferably produced from a multilayered molten-plastic film that has a first outer layer made of a polymer that is suitable for the production of a high-gloss surface, a core layer, and a second outer layer. The second outer layer can contain an antistick additive and/or have a matte film surface that does not stick to smooth surfaces. The layers are coextruded. The thickness of the core layer is such that an embossing of the second outer layer for producing a matte side of the film does not interfere with the surface of the first outer layer. Silicon dioxides, calcium carbonates, waxes, silicates, polybutenes and the like come into consideration as antistick additives.

With regard to the method according to the invention, a protective film can be produced that has a first outer layer made of an LD polyethylene, a core layer made of an MD polyethylene, and a second outer layer made of a mixture of PE-MD and polybutene (PB). The first outer layer has a high-gloss and zero-defect surface. The second outer layer has an embossed/matte surface or has, as a consequence of the polymer composition, antistick characteristics.

Using the method according to the invention, protective films can be produced that have a film thickness of at least 80 μm. Preferably, protective films are produced in a film thickness of 80 μm to 120 μm. In the production of thinner protective films, the described method becomes increasingly problematic as the film thickness decreases, because no polymer layer with sufficient cushioning between the cooling roll and the smoothing belt is present any more that equally distributes the pressure in the roll gap. This can cause irregularities on the film surface. In addition, there is the danger that the surfaces of the cooling roll and the smoothing belt will be slightly damaged. To the extent protective films are intended to be produced that have a film thickness of less than 80 μm, the following embodiments of the method in accordance with the invention can be used.

A first variant of the method provides that the protective film is produced by coextrusion in a composite with a release film that can be pulled off the protective film. The coextrusion composite consisting of the protective film and the release film has a total film thickness of at least 80 μm and is preferably produced in a film thickness of between 80 μm and 120 μm. Prior to using the protective film, the release film is removed and disposed of as waste. By using the method that was described, a protective film with a film thickness between 20 μm and 60 μm can be produced. Preferably, the protective film is made in two layers, with the outside layer that comes in contact with the cooling roll or with the smoothing belt forming a glossy layer with a high-gloss surface. The glossy layer forms the adhesion side of the protective film, which is placed onto the surface of the object that is to be protected. The second layer forms the outer side of the protective film. To the extent the protective film is removed from the release film only immediately prior to use, a rough surface of this second layer is not necessary, nor must the second layer be equipped with antistick additives. But it is also within the scope of the invention that the protective film is rolled up into a roll prior to use. In this case, the second layer of the protective film advantageously contains antistick additives to prevent sticking of the film windings.

According to a preferred embodiment of the invention, the release film has a separation layer contiguous to the protective film that is made of a polar polymer, a polyolefin support layer and an adhesion layer connecting the separation layer with the support layer. The adhesive force between the separation layer and a contiguous polyolefin layer of the protective film is significantly smaller than the adhesive force between the other layers of the coextrusion composite, so that the release film can be detached from the protective film without any residue and with little force. The adhesion between the separation layer and the contiguous surface protection layer is preferably exactly of such that further processing and a transport of the coextrusion composite consisting of the release film and the protective film are possible in a safe manner.

A further possibility for the production of protective films with thin film thicknesses according to the method of the invention consists in that two protective films are produced by coextrusion together with a separation layer between the protective films and are subsequently detached from the separation layer. The separation layer and the contiguous layers of the two protective films are coordinated with each other in terms of material in such a way that the layers can easily be separated from each other. Preferably, the protective films consist of polyolefins and the separation layer of a polar polymer, preferably of a polyamide or TPU. The coextrusion composite consisting of two protective films and a separating layer is produced in a total film thickness of at least 80 μm, preferably in a film thickness of between 80 μm and 120 μm. According to the method described, protective films can be produced that have a film thickness between 20 μm and 50 μm. The protective films that are detached from the separating layer prior to use are preferably two-layered, whereby one of the two layers forms a glossy layer with a high-gloss surface. The glossy layer comes into contact with the surface of the object that is to be protected. When using the protective film, the second layer forms the outer side and can contain antistick additives.

For the production of the coextrusion composite consisting of two protective films and a separation layer, the cooling roll and the smoothing belt must have a smooth contact surface that acts upon the molten-plastic film for producing a high-gloss film surface. In a composite with the separation layer, the first surface protection layer has, on its outer side that contacts the smoothing belt or the cooling roll, a high-gloss surface. Preferably, the layer structure of the second protective film that adheres to the separating layer is inverted. Here, the inner layer of the second protective film that is contiguous to the separation layer forms a glossy layer with a high-gloss surface after detachment from the separating layer, while the layer in the composite that is on the outside of the second protective film advantageously contains antistick additives. After coextrusion, the second protective film can be detached from the separating layer, separately rolled up and can be supplied to customers as a separate roll of film. The first protective film is advantageously rolled up into a role together with the separation layer, whereby the separation layer prevents sticking of the film windings on the roll.

The separation layer is detached from the first protective film only upon further processing of the protective film.

### BRIEF DESCRIPTION OF THE DRAWING

The above and other objects, features, and advantages will become more readily apparent from the following description, reference being made to the accompanying drawing in which:

FIG. 1 is a small-scale diagrammatic end view of a system for carrying out the film-making method of this invention; and

FIGS. 2 to 5 are sections through films in accordance with the invention.

### SPECIFIC DESCRIPTION

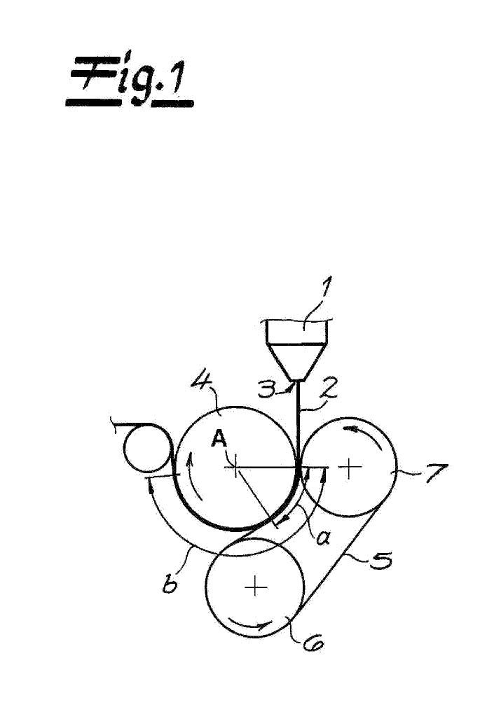

As seen in FIG. 1 an extruder 1 forces a film or sheet 2 of molten plastic from a slit nozzle 3. The film 2 is fed while still molten to a gap between a cooled roll 4 and a metal smoothing belt 5 so that it is cooled by contact with the roll 4. The belt 5 engages the roll 4 over an arcuate region a in which it bears radially inward with surface pressure on the film 2 to press it against the cooling roll 4. The belt 5 is continuous and is held taut between rollers 6 and 7 to exert the required compressive force on the workpiece strip 2. The belt 5 can be of steel. The belt tension, and the contact length of the smoothing belt 5 with the molten-plastic film 2 can be adjusted according to production requirements.

The compression region a in which the smoothing belt 5 acts upon the cooling roll 4 is smaller than the cooling region b in which the molten-plastic film 2 engages the cooling roll 4. The region a has an angular dimension relative to a rotation/center axis A of the roll 4 of between 15° and 90°, and the contact region b of slightly less than 180° to ensure that the smoothness imparted to the soft strip 2 in the region A

The cooling roll 4 and/or the smoothing belt 5 have a smooth contact surface that acts upon molten-plastic film 2 to give it at least one high-gloss face that preferably has a surface roughness of less than 10 μm. The surface roughness can be achieved by providing the belt 5 and/or roll 4 with a surface coating that imparts the required surface quality. Particularly preferred is a surface roughness of less than 1 μm.

One of the surfaces acting upon the molten-plastic film can be an embossed surface or rough surface in order to produce a matte film surface that does not stick to smooth surfaces. Such a matte surface is advantageous in that it prevents the finished film from sticking to itself when rolled up.

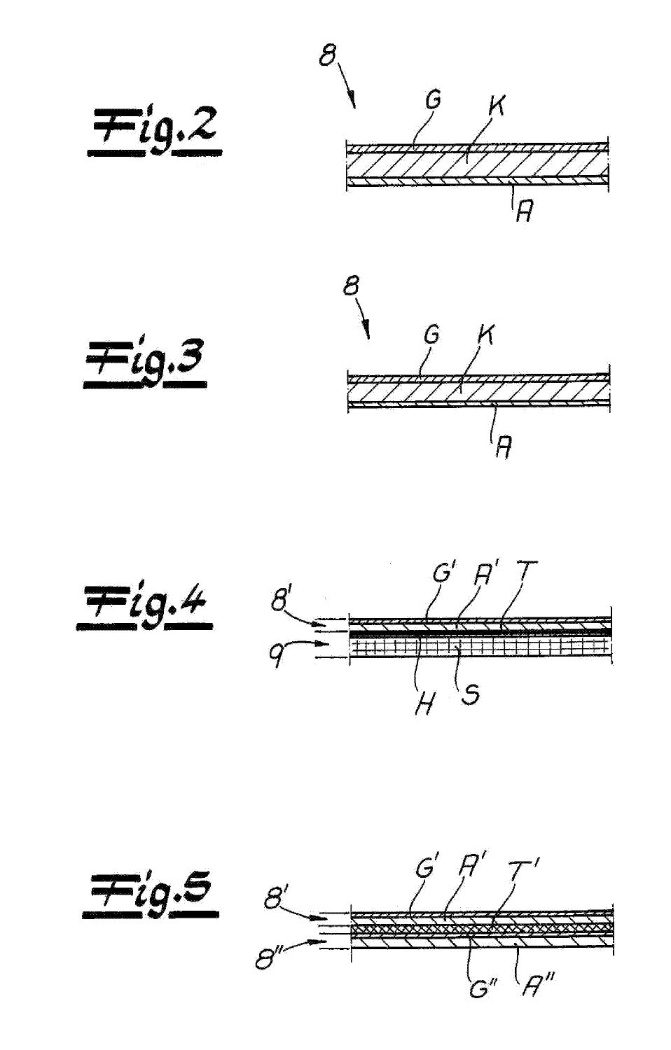

FIG. 2 shows a protective film 8 produced according to the described method. The protective film 8 has three layers, namely a glossy outer layer G of PE-LD with a high-gloss surface that is 20 μm thick, a core layer K of PE-MD that is 60 μm thick, and an outer layer A made of PE-MD that is 20 μm thick. The outer layer A has a matte surface that does not adhere to smooth surfaces.

The protective film 8 shown in FIG. 3 is also made of a three-layered molten-plastic film, with a glossy outer layer G of a polymer suited for producing a high-gloss surface, a core layer K, and an outer layer A. More particularly, this glossy outer layer G is made of PE-LD 15 μm thick, the core layer K is made of PE-MD 50 μm thick, and the outer layer A is 15 μm thick. The outer layer A also has a smooth surface and contains antistick additives. Furthermore, the outer layer A consists of a mixture of PE-MD and polybutene.

To make the protective film 8 shown in FIG. 3, the cooling roll 4, and the smoothing belt 5 have a smooth faces tranversely compress the molten-plastic film 2 to produce high-gloss face on both sides.

Three-layered protective films 8 produced with the described method can have a total thickness of at least 80 μm. In the production of such thin protective films 8, there is the problem that no polymer layers with sufficient cushioning are present between the cooling roll 4 and the smoothing belt 5 to evenly distribute pressure. Because of this, surface irregularities can result on the film. Further, there is the danger that the sensitive surfaces of the cooling roll 4 and the smoothing belt 5 will be damaged slightly.

For the production of protective film 8 with a film thickness of less than 80 μm, the protective film 8′ of FIG. 4 can therefore be produced by coextrusion along with a release film 9 that can be pulled off the protective film 8′ without leaving any residue behind. The coextrusion composite is produced from of a five-layer molten-plastic film, the layers G′ and A′ forming a two-layered protective film and the release film consisting of layers T, H and S. The outer layer of the five-layered molten-plastic film 2 comes into contact with the cooling roll 4 or the smoothing belt 5 and forms the glossy outer layer G′ of the protective film 8′ that consists of the glossy outer layer G′ and the layer A′. The release film 9 formed by coextrusion jointly with the protective film 8′ has a separation layer T made of a polar polymer contiguous with the protective film 8′, a polyolefin support layer S and an adhesive layer H that loosely bonds the separation layer T with the support layer S. The adhesive force between separation layer T and the polyolefin outer layer A′ of the protective film 8′ is smaller than the adhesive force between the other layers of the coextrusion composite, so that the release film 9 can be removed completely without any residue from the protective film 8′. In particular, the separation layer T can be made of a polyamide or of TPU.

The layer composite shown in FIG. 4 thus consists of a protective film 8′ with a glossy outer layer G′ made of PE-LD that is 10 μm thick, and an outer layer A′ made of PE-MD that is 20 μm thick, and a three-layered release film 9 with a separation layer T made of a polyamide that is 5 μm thick, an adhesive layer H made of MAH-PE-LLD (malic acid anhydride-modified PE-LLD) that is 5 μm thick, and a 50 μm thick support layer S made of PE-MD.

To make thin protective films with a film thickness between 20 μm and 50 μm, two protective films 8′ and 8″ can also be produced by coextrusion together with a separation layer T′ between the films 8′ and 8″, and can subsequently be separated from the separation layer T′. FIG. 5 shows a layer structure of such a coextrusion composite. The layers G′, A′ and G″, A″ form a two-layer film 8′, 8″ made of polyolefins between which a separation layer T′ is provided made of a polar polymer, for example, a polyamide or TPU. The first protective film 8′ with the layers G′, A′ has, along with the separation layer T′ at its outer side and in contact with the smoothing belt 5 or the cooling roll 4, a high-gloss surface. The layer structure of the second protective film 8″ with layers G″ and A″ is the opposite.

The inner layer of the second protective film 8″ that is contiguous with the separation layer T′ forms a glossy outer layer G″ with a high-gloss surface after detachment from the separation layer T′, while the exterior layer A″ of the second protective film 8″ contains antistick additives. The layer structure shown in FIG. 5 consists of a first protective film 8′ with a glossy outer layer G′ made of PE-LD that is 10 μm thick, an outer layer A′ made of PE-LD that is 20 μm thick, a second protective film 8″ with a glossy outer layer G″ made of PE-LD that is 10 μm thick, and an outer layer A″ made of PE-LD that is 30 μm thick and is made as an antistick layer made of PE-LD and polybutene, and a separation layer T′ that is 20 μm thick and made of polyamide that is located between the two protective films 8′, 8″. After producing the layered composite shown in FIG. 5, the first protective film 8′, is rolled up into a roll together with the separation layer T′, so that the separation layer T′ prevents the film windings from adhering to one another. The separation layer T′ is removed from the first protective film 8′ only later when used by the user. The second protective film 8″ is rolled up separately, so that the second protective film 8″ can also be processed as roll goods.

We claim:

1. A method of making a protective film, the method comprising the steps of:
extruding a molten-plastic film from a slit nozzle into a nip formed between an outer face of a rotatable roll and a face of a metal belt, one of the faces being smooth;
tensioning the belt and thereby pressing the film in the nip between the belt and the roll outer face; and
cooling the belt or the roll to harden the film such that one face of the film engaging the smooth face of the roll or belt is rendered smooth and free of defects.

2. The film-making method defined in claim 1 wherein the smooth face has a surface roughness of less than 10 μm.

3. The film-making method defined in claim 2 wherein the surface roughness is less than 1 μm.

4. The film-making method defined in claim 1 wherein the other face is nonsmooth so as to impart to an opposite face of the film a matte finish.

5. The film-making method defined in claim 1 wherein the belt presses the film against the roll face over an arc that is shorter than an arc over which the film engages the roll.

6. The film-making method defined in claim 5 wherein the arc along which the film is pressed against the roll has relative to a rotation axis of the roll an angular dimension between 15° and 90°.

7. The film-making method defined in claim 1 therein the film has an outer glossy layer made of a polymer, a core layer, and another outer layer.

8. The film-making method defined in claim 7 wherein the other outer layer has a matte finish.

9. The film-making method defined in claim 7 wherein the other outer layer contains antistick additives.

10. The film-making method defined in claim 1 wherein the film has a thickness between 80 μm and 120 μm.

11. The film-making method defined in claim 1 wherein the film has a thickness of less than 80 μm.

12. The film-making method defined in claim 1 wherein the protective film has two layers.

13. The film-making method defined in claim 1 wherein the protective film is coextruded with a separable release film.

14. The film-making method defined in claim 13 wherein the release film comprises
a separation layer that is contiguous with and engages the protective film and is formed of a polar polymer,
a polyolefin support layer, and
an adhesive layer connecting the separation layer with the support layer, an adhesive force between the separation layer and the protective film being smaller than the adhesive force between the other layers of the release film.

15. The film-making method defined in claim 1 wherein the slot nozzle extrudes a pair of protective films sandwiching a separation layer, the method further comprising the step of:
separating the protective films from the separation layer.

16. The film-making method defined in claim 16 wherein the protective films are of polyolefin and the separation layer is of a polar polymer.

17. The film-making method defined in claim 17 wherein the separation layer consists of a polyamide or TPU.

18. The film-making method defined in claim 16 wherein the coextruded protective films and separation layer have a combined thickness of less than 80 μm.

19. The film-making method defined in claim 16 wherein each of the protective films has two layers.

20. The film-making method defined in claim 16 wherein one of the protective films has a layer with a glossy surface turned away from the separation layer and the other of the protective films has a layer containing antistick additives and with a glossy surface turned toward and engaging the separation layer.
